(19) United States
(12) Patent Application Publication
(10) Pub. No.: US 2002/0023030 A1
(43) Pub. Date: Feb. 21, 2002

(54) Third party payor method and system for distributing financial benefits

(76) Inventors: Daniel Prohaska, Seattle, WA (US); Thomas Prohaska, Coeur d' Alene, ID (US)

Correspondence Address: DORSEY & WHITNEY LLP, SUITE 3400, 1420 FIFTH AVENUE, SEATTLE, WA, 98101, US

(21) Appl. No.: 09/858,145

(22) Filed: May 14, 2001

Related U.S. Application Data
(60) Provisional application No. 60/203,730, filed on May 12, 2000.

(51) Int. Cl. G06F 17/60

(52) U.S. Cl. 705/35

(57) ABSTRACT

A method and system is provided to distribute benefits to a client, and compensate a first entity, such as an attorney, for providing a first type service to the client. The method includes establishing a relationship between the first entity and the client where the first entity provides a first type of service to the client, the entity being under an obligation not to accept fees for referring the client to a third entity which provides the benefit as a second type of service. The client is referred to the third the entity, which provides the benefit and charges a fee to the client for providing the benefit. The third entity compensates the first entity for the first type of services provided to the client from a portion of the fees charged to the client by the third entity. The method complies with ethical rules governing the professional conduct of the first entity.

### CROSS REFERENCE TO RELATED APPLICATIONS

This application claims the benefit of U.S. provisional application No. 60/203,730, filed May 12, 2000, which is incorporated herein by reference.

### TECHNICAL FIELD

This invention relates generally to the field of business methods and more particularly to methods of providing a benefit from a benefit provider, such as an asset management entity, to an entity such as a client, while also providing a service to the client, such as a legal service, from a separate service provider, where the service provider is compensated by the benefit provider under a third-party payor method that complies with the ethical and statutory rules governing the conduct of the service provider.

### BACKGROUND OF THE INVENTION

Benefit management is an important component to successful maintenance and transmission of wealth, especially wealth accumulated by individuals. A benefit includes anything of value, such as an asset or investment that is provided to a person (or designee of the person) for which the person is willing to pay a fee to obtain or manage. Wealth is typically managed by being distributed into a variety of benefits with the help of the services provided by one or more professional entities. A person that uses such services becomes a client of each entity providing a service. Clients traditionally have relied on legal services provided by attorneys to help implement a wealth management or estate planning plan. The attorney's service to the client is a counseling relationship that takes into consideration the client's personal goals, the tax consequences and inter relationship between various investments and instruments viewed in light of a variety of legal issues that can affect realization of the individual's goal. Attorneys usually become trusted advisers of their clients because unlike other service professionals, an attorney is privy to a multitude of personal confidences of the client. In providing wealth planning services, the attorney might refer the client to the services of benefit providers, such as accountants or asset managers, who are authorized to render services related to financial matters, or to other benefit providers such as a securities broker, a banking institution or other entity authorized to provide specific types of financial vehicles related to specific classes of benefits. Typically, these other entities are not able to provide (or are prevented by governmental rules from providing) advice that is strictly legal in nature. Moreover, certain instruments for conveying assets, such as wills, trusts and estates, are legal in nature, and cannot be prepared by the benefit provider although such instruments may include benefits that are managed by the same.

The traditional business model for distributing benefits and legal services to a client may be designated the independent referral model, which is illustrated in FIG. 1A. A client 100 establishes a relationship with an attorney 110 who provides legal services 115 to the client in return for a fee 118. In the case of wealth management services, the attorney 110 would typically recommend that the client 100 retain an entity to provide a benefit, such as asset management, 125 and would often make specific referrals 130 to use the services of a particular benefit provider/asset manager 120. The client 100 would then establish an independent relationship with the benefit provider 120 whose services include, for example, providing and/or managing an asset 125 for the client, so that the client 100 receives a benefit 126 resulting from the management. The benefit provider 120 performs these services in return for another fee 128. Typically, fees 128 charged by the benefit provider are paid by the client on a periodic basis, for example, monthly, quarterly or annually, with the amount of the fee often being proportionate to the value of the benefit provided or asset managed. Thus, the benefit provider 120 obtains an ongoing revenue stream from the client 100 based on the value of the benefit or asset for as long as the benefit or asset is managed by the benefit provider 120.

In contrast, the attorney 110, who is often principally responsible for designing the overall wealth planning plan for the client 100, might only receive the initial fee 118 for rendering the initial planning services 115. The rules governing the conduct of attorneys in most jurisdictions prevent attorneys from receiving fees from the benefit provider 120 or from the client 100 for making the referral. Accordingly, the benefit provider 120 receives a continuous, and potentially large revenue stream 128 that originated from the expertise in wealth planning initially provided by the attorney 110 as well as the benefit of the referral by the attorney. In addition, the client 100 is required to pay two separate fees (118 and 128) to obtain the legal services 115 of the attorney 110 and the benefit 125 from the benefit provider 120. Therefore, in this referral model, the role played by the attorney 110 provides a long-term financial benefit to both to the client 100 and the benefit provider 120. Although the client 100 pays the fee 118 for this service 115, the benefit provider 120 receives the benefit of the referral 130 from the attorney 110 free-of-charge.

A second model for providing a benefit to a client 100 using the expertise of an attorney 110 is the attorney-employee model currently practiced by several accounting and brokerage firms, which is illustrated in FIG. 1B. In this model, the benefit provider 120 hires attorney-employees 123 to provide similar services 113 to the client 100 as the services 115 provided by an independent attorney 110 in designing a plan to manage the client's wealth. The attorney serving in this capacity is a representative of the benefit provider and not the client. In using the services 113 of the employee attorney 123, the client 100 loses the benefit of having an independent counselor. Also, the attorney-employee model shown in FIG. 1B produces competition between the benefit provider 120 and independent attorneys 110, particularly in the field of wealth planning services. Yet it may be in the best interest of the client 100 for the attorney 110 to refer the client 100 to the benefit provider 120. In addition, the accounting firm or other benefit provider 120 charges fees for both planning services for and providing or managing the client's benefits , which the independent attorney is prevented from doing when the management of benefits or assets is provided by another party. This makes it difficult for independent attorneys to be compensated on par with those that provide essentially identical services but who are not under an obligation that prevents them from accepting fees for providing the dual services of planning and management.

A third model designed to bring the professional services of a benefit provider 120 and an attorney 147 into one business is the Multi-Disciplinary Practice (MDP) 140, which is illustrated in FIG. 1C. The MDP 140 is a partnership, corporation, or other legal entity formed between a benefit provider 120, an attorney 147 or group of attorneys, or other professionals such as accountants 150. The client 100 can ostensibly obtain a suite of professional services from each of the separate disciplines associated with the MDP 140 in exchange for a fee 145 that includes the separate fees 144 from each service provided. Each of the professional services provided by the MDP 140 is governed by the ethical and statutory requirements for that discipline. The potential attraction of the MDP 140 is that any one service provider 147, 120 or 150 operating within the MDP 140 may refer clients to another service provider within the MDP 140 while the overall profits of the MDP 140 are shared between various disciplines. The MDP model, however, has numerous problems that make it impractical and/or otherwise undesirable. Currently, few jurisdictions permit attorneys to form business partnerships with non-attorneys, so MDPs 140 cannot be formed in many places. Where such practices can be formed, they face strict structural and regulatory rules that increase liability and the cost of providing services. Also, to be competitive, MDPs require a certain “critical mass” of professional service providers to form the entity. Obtaining such a critical mass is impractical for smaller law firms, banks and accounting firms that serve many communities in the United States.

A fourth model for distributing legal services and benefits to clients is the multiply-licensed professional model, which is illustrated in Figure 1D. This model include a multiply-licensed professional 160 who is a professional licensed to practice in one discipline that also obtains a separate license to practice in a different discipline. For example, an attorney may obtain a real estate license, a securities broker's license, an insurance license or the like. Each professional service is independent of the other services although a single person is licensed to practice in each discipline. The multiply-licensed professional 150 is separately subject to the ethical rules governing each discipline. These ethical rules may at times conflict. They also might require the multiply-licensed professional 150 to create two or more separate entities and may prohibit sharing space, advertising costs or administrative personnel between entities. It is often more desirable for an attorney to close his or her legal practice altogether rather than risk violating the ethical rules of professional conduct when operating under separate professional licenses. Again, this model is not desirable to many attorneys that prefer to continue the practice of law.

Each of the foregoing business models may fail to provide satisfactory results for a large number of clients and attorneys. Clients may not have the ability to use their existing attorney as a counselor to manage the client's benefits without having to pay additional fees. There maybe little or no oversight of the benefits being managed by the benefit provider when there is no independent attorney overseeing the benefits under management. In addition, many attorneys, especially those that are skilled in wealth planning services are faced with the “if you can't beat them join them” dilemma of having to give up their existing legal practices and enroll with a benefit provider if the attorney cannot compete economically with other benefit providers providing similar wealth planning services. A new business model is needed to overcome these problems.

### BRIEF SUMMARY OF THE INVENTION

There is a need in the art to provide a method that allows attorneys (or other professional entity under an obligation to not accept fees for referral services) to continue to provide services related to a benefit provided to their clients, and to be compensated for those services while the actual provision or management of the benefit is referred to another entity.

Provided herein are methods and systems to provide a benefit to a client under third party payor compensation system where the client uses at least two types of services to obtain a benefit and pays a single fee for the distinct types of services in compliance with an ethical rule, license requirement or governmental statute governing the conduct of the entity being compensated by the third party. In one embodiment, the method includes establishing a first relationship between a client and an the attorney, the attorney providing legal services to the client concerning the client's benefits and being under an obligation to not accept fees for referring the client to a benefit provider. A second relationship is established between the client and a benefit provider, the benefit provider charging a fee to the client to manage the assets of the client. A third relationship is established between the benefit provider and the attorney, the attorney referring the client to the benefit provider and the benefit provider compensating the attorney for legal services provided to the client, the compensation received by the attorney being in compliance with rules governing the ethics of the practice of law. In preferred embodiments, the benefit is an asset or asset management service and the benefit provider is a bank, trust company, broker or other financial services entity.

The method is generally applicable to providing services and benefits to any entity seeking a service and a benefit and is applicable to service provider entities other than attorneys, and to benefits other than asset management. In a more general embodiment, the method includes a first entity providing a first type of service to a second entity, the first entity being able to accept fees for the first type of service but under an obligation not to accept fees for providing a first benefit to the second entity and/or for making a referral to a third entity that provides the first benefit to the second entity. The second entity may be a client, customer or other entity seeking services and benefits. The first entity may be any entity that provides the first type of service. The third entity may be any entity that provides the first benefit sought by the second entity. The method also includes a third entity providing the first benefit for the second entity, the third entity being able to accept fees from the second entity for providing the first benefit. The method still further includes providing a third entity that compensates the first entity for the first type of service the first entity provides to the second entity from fees the third entity charges the second entity for providing the first benefit. In certain embodiments, the first entity may refer the second entity to the third entity. In yet other embodiments. the third entity may refer the first entity to the second entity. In any case, the third party payor system establishes a set of relationships between the entities, the services and the benefits provided in a manner that complies with the ethical obligations of the entities being compensated.

Also provided are document and electronically based systems for establishing the relationships necessary to provide the third-party payor method and for distributing the benefits and services. These and other embodiments of the invention may be more fully understood by reference the following detailed description.

### BRIEF DESCRIPTION OF THE DRAWINGS

FIG. 1A is a schematic diagram that illustrates an independent referral method of the prior art for providing benefits and legal services to a client.

FIG. 1B is a schematic diagram that illustrates an attorney-employee method of the prior art.

FIG. 1C is a schematic diagram that illustrates a Multi-Disciplinary-Practice method of the prior art.

FIG. 1D is a schematic diagram that illustrates a multiply-licensed professional method of the prior art.

FIG. 2 is a schematic diagram that illustrates one embodiment of a third party compensation method provided herein.

FIG. 3 is a schematic diagram that illustrates a computer based embodiment of the method of the present invention.

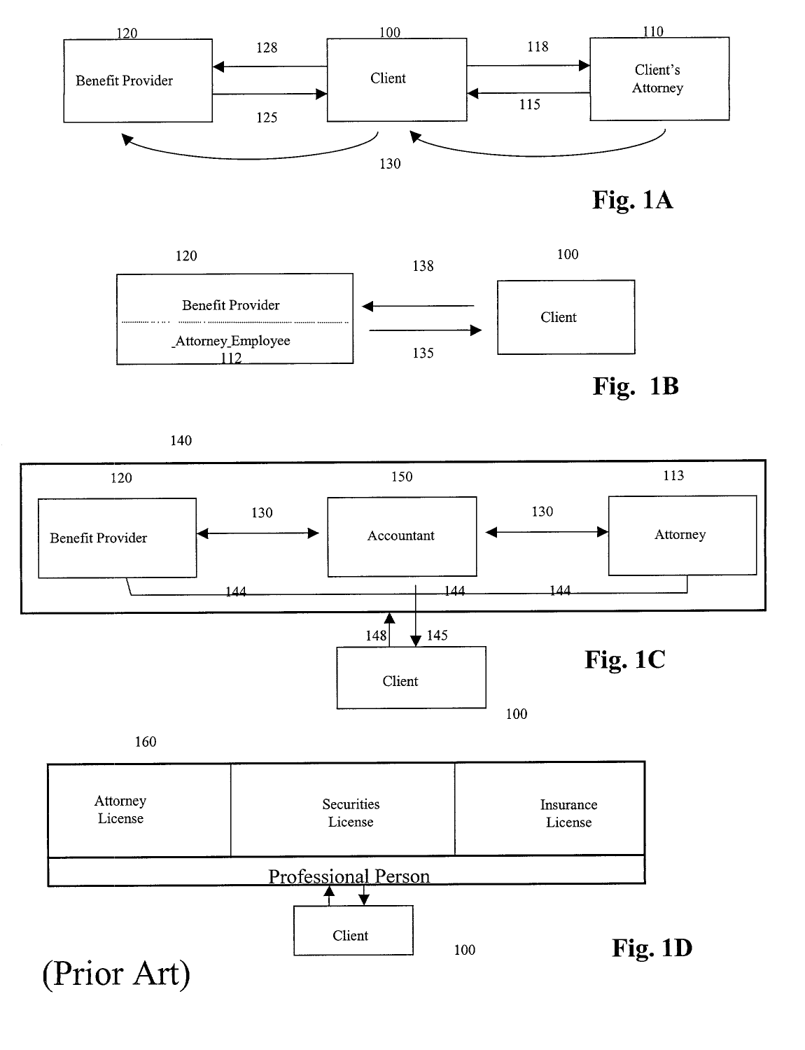

### DETAILED DESCRIPTION OF THE INVENTION

As mentioned in the foregoing summary, the methods and systems provided herein are applicable to a variety of relationships between a client, a first entity that provides a first service for the client, and a third-party entity that provides or manages a benefit of the client. To better aid in understanding the invention, the following detailed description is made with reference to embodiments where first entity providing the first service is an attorney providing a legal services, particularly wealth planning services (e.g. estate planning), and the third-party entity, the benefit provider, is a banking entity that provides investment vehicles and related advisory services for managing the assets of a client. However, it will be understood that this embodiment is for example purposes only, and that the method and systems provided herein can be applied to a wide variety of three party relationships.

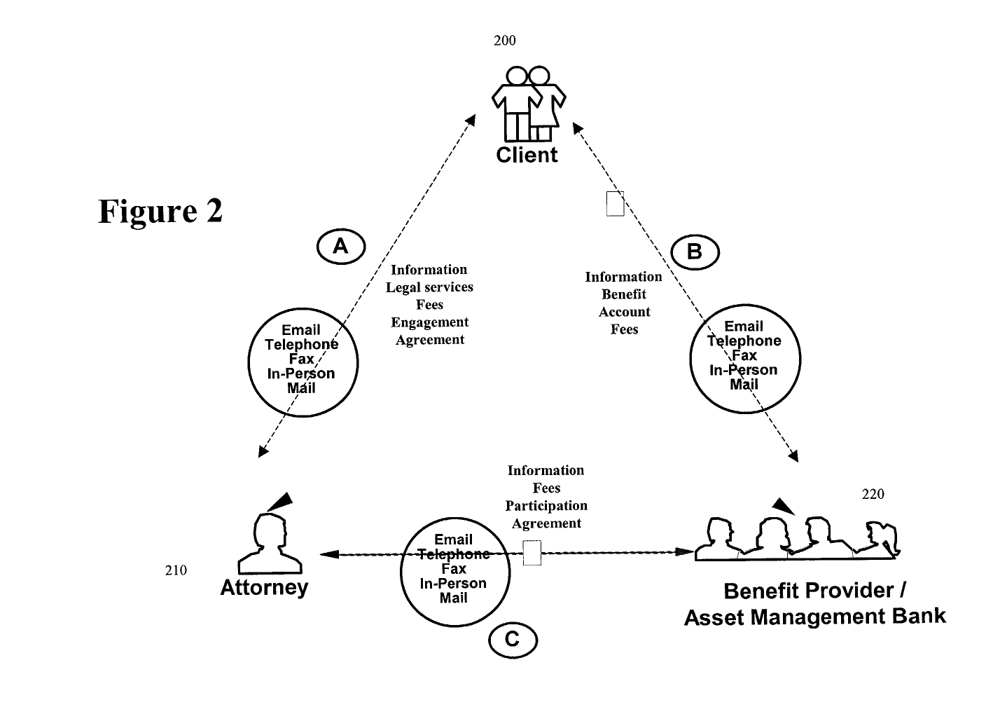

FIG. 2 illustrates various features of this embodiment. One or more clients 200 enter into a relationship A with an attorney 210. The attorney client relationship A is an independent relationship between the client 200 and the attorney 210. The client 200 selects the attorney 210 to provide legal advice and usually has a preexisting relationship with he attorney 210. This relationship involves a two-way exchange of information concerning the client's personal and financial needs and legal services to aid in fulfilling those needs. In a preferred practice, the legal services provided by the attorney 210 relate to managing the client's wealth in an estate planning practice. As part of the service, the attorney 210 makes recommendations, reviews documents, prepares legal instruments and otherwise devises a plan to fulfill the particular needs of the client 200.

This first relationship between the attorney 210 and client 200 includes an engagement agreement that comports with the ethical rules governing attorney conduct, including a disclosure that the attorney 210 may recommend a particular benefit provider 220 to manage benefits on behalf of the client 200. A form of the engagement agreement may be provided as a document from the benefit provider 220. The engagement agreement discloses that the attorney 210 will provide ongoing counseling to the client 200 regarding the management of those client's benefits and that the fees for those ongoing services performed by the attorney 210 will be paid from the benefit provider 220 under a defined schedule. The agreement specifies that the services provided by the attorney 210 will remain confidential between the attorney 210 and the client 200, unless disclosure is consented to by the client 200. The attorney 210 retains a duty of loyalty to the client 200 as required by the ethical rules governing the conduct of the attorneys. This includes the duty to represent the client's interest where it may depart from the interest of the benefit provider 220. If the client 200 elects to use the benefit provider 220 recommended by the attorney 210, the engagement agreement between the attorney 210 and client is filed with the benefit provider 220 to document that the first relationship has been established.

The second relationship B is established between the client 200 and the benefit provider 220 where information and services for managing the benefits provided to the client 200 are exchanged between these parties in return for a fee to be paid to the benefit provider 220. The type of benefits to be managed by the benefit provider 220 preferably includes those recommended by the attorney 210, but may include other benefits independently recommended by the benefit provider 220 in light of the plan devised between the attorney 210 and the client 200. For example, the attorney 210 might generally recommend benefits such as a trust fund, securities investment, a real estate investment, a cash asset account and the like. The benefit provider 220 in turn, might recommend a particular distribution of financial products into which to invest the funds of the trust, and/or recommends particular securities or mutual finds that comport with the plan. The client 200 may further consult with attorney 210 regarding the recommendations of the benefit provider 220. If the client 200 elects use the services of the benefit provider 220 these parties review, execute and file an account agreement with the benefit provider 220. The account agreement documents that the second relationship has been established and an account is provided for the client 200 by the benefit provider 220 to manage the benefits to be provided. The client 200 and/or the benefit provider 220 notifies the attorney 210 that the second relationship has been established.

A third relationship C is then established between the benefit provider 220 and the attorney 210. This relationship includes a participation agreement that is produced, reviewed and executed between the attorney 210 and the benefit provider 220. This agreement typically provides that the attorney 210 will perform a minimum set of legal services to independently advise the client 200 about the benefits being managed by the benefit provider 220. The agreement also includes a compensation plan specifying that the attorney 210 will be compensated for the legal services provided to the client 200 under the terms of the engagement agreement between the client 200 and the attorney 210, the compensation for such services being provided from the fees charged to the client 200 by the benefit provider 220. The participation agreement documents that the third relationship has been established.

The benefit provider 220 preferably provides the attorney 210 with access to the client's benefit account to allow the attorney 210 to oversee the performance of the account and to properly advise the client 200. The benefit provider 220 may also provide the attorney 210 with information concerning the benefit management services available from the benefit provider 220. In addition, the benefit provider 220 may also provide the attorney 210 with proprietary information or other instructional materials related to serving the legal needs of clients 200.

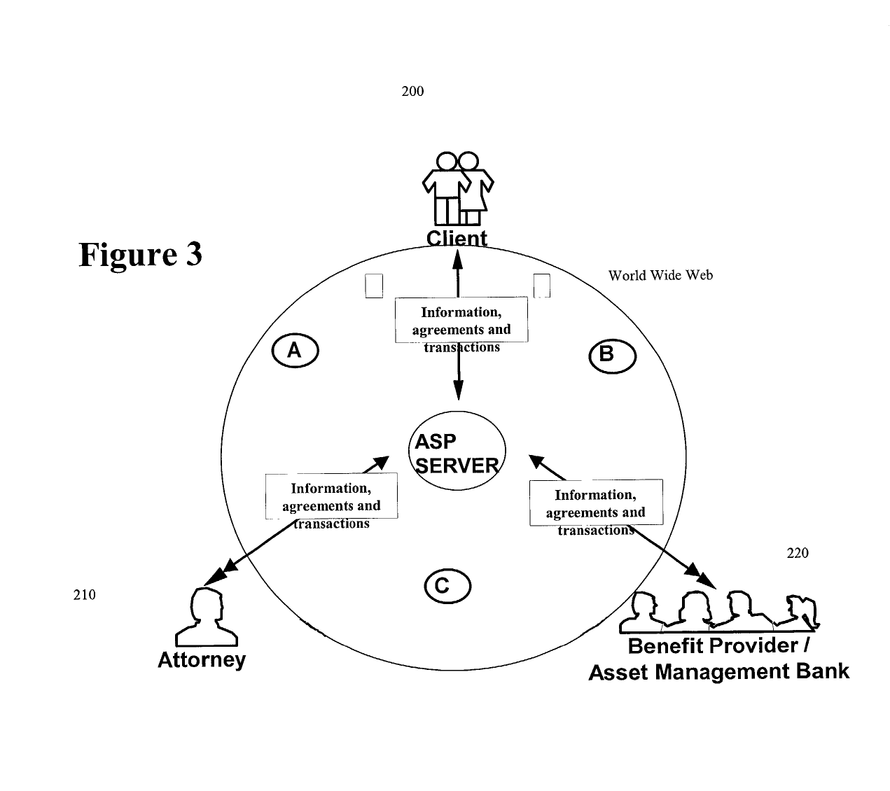

It will be understood that the relationship between the attorney 210 and benefit provider 220 may differ from that described above. In the embodiment shown in FIG. 2, the relationships A, B and C between the client 200, attorney 210, and benefit provider 220 are established and maintained through the creation of documents and exchange of information through communication channels 225 such as telephone, facsimile, in-person meetings and mail. In a preferred embodiment, the relationships A, B, C are established through electronic communication channels utilizing computer communication medium. FIG. 3 illustrates this embodiment for providing benefits to a client 200 using the third party payor system. This embodiment, like the embodiment described in FIG. 2 is based on establishing three independent relationships, i.e., between the client 200 and attorney 210, the client 200 and benefit provider 220, and the attorney 210 and the benefit provider 220. This embodiment is implemented by providing the necessary information for establishing the relationships on computer readable medium, preferably over a network such as the Internet or World Wide Web. In one practice of this embodiment, rather than providing hard-copy documents for establishing the relationships, the relationships are established by electronic communication. In a typical practice, an application service provider (ASP) provides the information on computer readable medium via a server computer. The client 200, the benefit provider 220 and the attorney 210 each communicate information by a carrier wave from local computers distributed at various places to one or more server computers.

In certain embodiments, the computer communication medium includes computer readable medium configured to provide information identifying the set of member attorneys that have established the third relationship with benefit provider 220. This information may be stored for example, in the form of a database that also includes information identifying the corresponding set of clients for each member attorney 210 that has established a relationship with the benefit provider 220. In still other embodiments the computer communications medium is further configured to provide secure account information regarding the client's account being managed by the benefit provider 220 for the client 200. In this practice, the account information is accessible to the client 200, the benefit provider 220 and the attorney 210. In addition, the ASP embodiments may further provide information to the client 200 and to the attorney 210 concerning services offered by the benefit provider 220 for managing the benefit of the client 200. Also, the ASP may transmit certain selected information to the attorney 210 such as, for example, instructional materials to aid the attorney 210 in providing legal services for the client 200.

The third party compensation method provided herein provides for the affiliation of a plurality of member attorneys 210 with a benefit provider 220. This membership of attorneys provides a network to distribute benefits provided by the benefit provider 220. An attorney becomes an affiliated member only if the attorney refers the service of the benefit provider 220 to at least one client 200 and the client 200 accepts the service provided. By becoming an affiliated member, the attorney 210 is “enlisted” as part of a network of independent attorneys, each referring the benefit provider 220 to a client 200 and thereby distributing the benefits provided by the benefit provider 220. Because the network of member attorneys may be established using computer communications media provided over the Internet, a large benefit distribution system can be provided at a lower cost than the typical attorney-employee method or MDP method of the prior art. The benefit provider 220 can accordingly charge competitive fees for providing or managing the benefit while at the same time being able to compensate the member attorneys 210s for legal services provided to their clients.

The agreement between the attorney 210 and the benefit provider 220 may require that the attorney 210 provide a defined amount or type of legal services to the client 200 over a defined period of time. Typically, the defined amount of services is expressed in units of time while the defined type of services is expressed as typical attorney functions, for example reviewing the benefits under management by the benefit provider 220 in light of any changes in the client's goals, reviewing tax consequences and the like. While the amount or type of services may be specified, it remains in the sole discretion of the attorney 210 to determine the form and content of any service provided to the client 200. In any case, the attorney 210 is compensated only for providing legal services. The compensation is provided on a periodic basis, for example, annually or biannually. The compensation may include payment for the initial services, such as wealth planning services rendered to the client 200 prior to the client 200 having established a relationship with the benefit provider 220. Preferably, before any compensation is paid to the attorney 210, the attorney 210 submits a document certifying to the benefit provider 220 that legal services have been provided to the client 200 according to the engagement agreement. The client 200 also submits a document to the benefit provider 220 confirming that the attorney's certification is correct.

In certain embodiments, the fee charged by the benefit provider 220 for managing the client's benefits may be proportionate to the value of the benefit. In other embodiments the fee charged by the benefit provider 220 may be a fixed amount. In a preferred practice, the benefit provider 220 charges a fee that is competitive with the fees charged by other benefit providers 220. A fee of 2% per annum or less of value of the assets under management would be competitive in most situations. In one embodiment, a fee of 1.95% per annum is charged by the benefit provider 220. In another embodiment, where the benefits under management are of a high value, a lower rate may be negotiated between the client 200 and the benefit provider 220. In such circumstance, one of the services provided by the attorney 210 under the engagement agreement with the client 200 may be to negotiate with the benefit provider 220 to offer a lower fee to the client 200. This presents no conflict of interests so long as the compensation fee paid to the attorney 210 is not changed because that compensation has been previously authorized by the client 200 in the engagement agreement. In most embodiments, the fees will be paid to the attorney 210 from earnings on the benefit being managed, especially when the benefit is an investment. In other embodiments, the fees may be billed and paid apart from the earnings on the asset.

To reduce the likelihood of conflicts of interest that might arise if the relationship A between the attorney 210 and the client 200, or the relationship B between the client 200 and the benefit provider 220 should deteriorate, the third party payor method provided herein may be made contingent on maintaining these relationships. In this practice, the affiliation of each attorney member 210 with the benefit provider 220 is conditioned on there being at least one client 200 of the member attorney 210 with a benefit being managed by the benefit provider 220. In addition, continued management of a benefit by the benefit provider 220 is conditioned on the client 200 receiving legal services by an affiliated member attorney 210. If the attorney 210 should withdraw from providing services to the client 200 then the client 200 is required to transfer benefits being managed by the benefit provider 220 to another benefit provider selected by the client 200. Similarly, if the client 200 should withdraw all accounts being managed by the benefit provider 220, then the membership of the affiliated attorney 210 with the benefit provider 220 is also terminated with respect to that client 200. These features help ensure that the attorney 210 will not be compensated if the client 200 dissolves the relationship with the attorney 210 and that the client 200 is always represented by an attorney 210 with respect the benefits being managed.

In the method and systems described herein, the client 200 may retain an attorney 210 originally selected by the client 200 who is familiar with the client's overall personal and legal needs. The client 200 need not rely on the counsel of an attorney employee of the benefits provider who's loyalties lie with the benefits provider. The client 200 preferably receives periodic counseling from the attorney 210 and does not incur additional fees when his or her own attorney 210 reviews the performance of the benefits provided from the benefits provider. The attorney 210 maintains his or her independence as client advisor and receives ongoing compensation for the legal services provided to the client 200 in compliance with the ethical rules governing attorneys. The benefit provider 220 obtains a method for distributing its benefits through a body of affiliated member attorneys 210 who can provide the wealth management expertise needed to adequately advise the clients. The independent body of attorneys are willing to recommend the benefit provider 220 to their own clients knowing that as attorneys, they will be able to provide ongoing oversight on behalf of their client's potentially changing goals and receive a reasonable fee for doing the same.

The third party compensation method provided herein is analogous to the role of a liability insurance company that serves as the third party payor to an attorney who represents the interest of the client in a matter covered by the terms of the insurance policy. In both cases the third party payor relationship comports with ethical rules because the services provided by the attorney 210 to the client are not put at risk by the third-party payor. However, the method provided herein differs from insurance in several respects. One difference is that in the present method, the client 200 receives periodic legal services without any triggering event. In contrast, services paid by insurers are not provided unless a triggering event occurs within the terms of the insurance policy. Another difference is that the legal services in the present method help manage a benefit of a client 200 rather than avoid (or minimize) a liability. In this respect, the third-party payor of the present invention has interests that are aligned with those of the client rather than being adverse thereto.

From the foregoing it will be appreciated that, although specific embodiments of the invention have been described herein for purposes of illustration, various modifications may be made without deviating from the spirit and scope of the invention. More specifically, although the embodiments described above have been described in the context of an attorney rendering legal services to a client and being compensated for those services by an entity who manages the benefit of the client, other arrangements are possible within the scope of the invention. The first type of service may be any type of service provided by any entity able to provide that service. Examples include, but are not limited to, professional counseling or advising services such as business management services, investment services, accounting services, medical services, psychological services and the like. Still other types of services include employment services, architectural services, contractor services, repair services and the like. Example benefits include financial assets such as securities investments, mutual funds, various forms of banking accounts, real estate investments, cash accounts, insurance policies and the like. These may be included in fiduciary accounts, such as trusts, conservatorships and executorships. When the benefit involves a fiduciary account, the client may be the trustee of the account and the benefit provider may manage the account as an agent of the trustee. Alternatively, the benefit provider may be the fiduciary, i.e. the trustee, conservator, or executor of a fiduciary account where the client is the grantor. In still another embodiment, the client may be the beneficiary of a fiduciary account granted by another but managed by a benefit provider who serves as the trustee, conservator, executor or agent of the account. Still other benefits include interests in personal property, for example, investments in art or other collectible items. Other property benefits include leases on real or personal property, for example a building lease or lease on a vehicle such as boat, plane or automobile. Example entities providing such benefits include trust companies, securities brokers, mutual fund companies, accounting firms, as well as a entities such as real estate brokers, real property management firms, insurance companies and personal property dealerships. Accordingly, the invention is not limited except as by the following claims.

What is claimed is:

1. A method of conducting transactions, comprising:
a first entity providing a first type of service to a second entity, the first entity being able to accept fees for the first type of service but under an obligation not to accept fees for providing a first benefit to the second entity and/or making a referral to a third entity that provides the first benefit to the second entity;
the third entity performing the first benefit for the second entity, the third entity being able to accept fees from the second entity for providing the first benefit; and
the third entity compensating the first entity for the first type of service the first entity provides to the second entity from fees the third entity charges the second entity for providing the first benefit.

2. The method of claim 1 wherein the first benefit comprises a second type of service performed by the third entity for the second entity.

3. The method of claim 2 wherein the first entity comprises an attorney, the second entity comprises a client, and the first type of service comprises legal services.

4. The method of claim 3 wherein the obligation not to accept fees for providing the first benefit and/or making a referral to a third entity that provides the first benefit comprises an ethical rule, license requirement or statute governing the conduct of attorneys.

5. The method of claim 3 wherein the third entity comprises an asset manager, the second type of service comprises managing assets owned by the first entity, and the legal services comprise counseling the client regarding the assets managed by the asset manager.

6. The method of claim 3 wherein the legal services comprise a wealth or estate planning service.

7. The method of claim 1 wherein the first type of service comprises an accounting service, the first entity comprises a licensed accountant, and the obligation not to accept fees for providing a first benefit to the second entity comprises an ethical rule, license requirement or statute governing the conduct of accountants.

8. The method of claim 7 wherein the accounting service comprises asset managing services.

9. The method of claim 1 wherein the first type of service comprises an investment advisor service, the first entity comprises a licensed investment advisor, and the obligation not to accept fees for providing a first benefit to the second entity comprises an ethical rule, license requirement or statute governing the conduct of investment advisors.

10. The method of claim 9 wherein the investment advisor service comprises asset managing services.

11. The method of claim 2 wherein the second type of service comprises an asset management service managing assets owned by the third entity.

12. The method of claim 2 wherein the second type of service comprises a banking service managing an account for the third entity.

13. The method of claim 2 wherein the second type of service comprises a securities brokerage service for investments owned by the third entity.

14. The method of claim 2 wherein the second type of service includes management of a fiduciary instrument and the third entity is a fiduciary or agent of the fiduciary and the second entity is the grantor or beneficiary of the fiduciary instrument.

15. The method of claim 14 wherein the fiduciary instrument comprises a trust.

16. The method of claim 14 wherein the fiduciary instrument comprises a conservatorship.

17. The method of claim 14 wherein the fiduciary instrument comprises an executorship.

18. The method of claim 2 wherein the second type of service comprises insurance brokering services for an insurance policy involving the second entity.

19. The method of claim 2 wherein the second type of service comprises a real estate brokering service for real estate owned by the second entity.

20. The method of claim 2 wherein the second type of service comprises a personal property brokering service for personal property owned by the second entity.

21. The method of claim 2 wherein the second type of service comprises a property management service for a lease on real or personal property owned by the second entity.

22. The method of claim 1 wherein the obligation not to accept fees for providing a first benefit to the second entity and/or making a referral to a third entity that provides the first benefit to the second entity comprises an obligation not to accept fees for providing the first benefit to the second entity.

23. The method of claim 1 wherein the obligation not to accept fees for providing a first benefit to the second entity and/or making a referral to a third entity that provides the first benefit to the second entity comprises an obligation not to accept fees for making a referral to the third entity.

24. The method of claim 1 wherein the first type of service is provided to the second entity on a periodic basis and the first entity is compensated on a periodic basis over a period of time that the benefit is being provided by the third entity.

25. The method of claim 1 wherein the first entity is compensated as a proportion of the value of the benefit provided to the second entity by the third entity.

26. The method of claim 1 wherein the first entity is compensated from fees charged by the third entity for providing the benefit over a period of time.

27. The method of claim 1 wherein the first entity is selected by the second entity, and the method further comprises the third entity referring the first entity to the second entity.

28. The method of claim 1, further comprising the third entity providing a membership affiliation with a plurality of first entity members, each first entity member referring at least one of the second entities to the third entity.

29. The method of claim 28 wherein the membership affiliation comprises an agreement between the first entity and the third entity, the agreement providing that the first entity is required to provide a defined amount of the first type of services for the second entity over a defined period of time.

30. The method of claim 28, further comprising the third entity providing an affiliated first entity member with instructional materials regarding the benefit provided by the third entity.

31. The method of claim 28 further comprising the third entity providing an affiliated first entity with instructional materials regarding the first type of services provided by the first entity.

32. The method of claim 28, further comprising the third entity providing the first entity member with secure access to an account that includes periodically updated information concerning the benefit provided by the third entity to each second entity that the first entity refers to the third entity.

33. The method of claim 28, further comprising the third referring prospective second entities seeking the first type of service to affiliated first entities.

34. The method of claim 28 wherein the membership affiliation is provided over a computer network.

35. The method of claim 32 wherein the computer network comprises the Internet.

36. The method of claim 28 wherein the affiliation of each first entity member is conditioned on there being at least one second entity to which the first entity has provided or will provide the first type of service with respect to the benefit provided by the third entity, the benefit provided by the third entity being conditioned on the second entity receiving the first type of services from the first entity.

37. A method of providing legal services to a client, comprising
enlisting at least one attorney to provide the legal services to the client, the attorney being under an obligation not to accept fees for referring the client to an asset management entity;
referring the client to the asset management entity, the asset management entity charging a fee to the client for managing the asset, and
the asset management entity compensating the attorney for the legal services provided to the client by paying the attorney a portion of the fees the asset management entity charges the client for managing the asset.

38. The method of claim 37 wherein the legal services comprise estate planning services.

39. The method of claim 37 wherein the asset management entity provides a banking service for managing a financial investment owned by the client.

40. The method of claim 37 wherein the asset management entity provides a securities brokerage service for securities investment owned by the client.

41. The method of claim 37 wherein the provides a banking service for an account owned by the client and managed by the banking service.

42. The method of claim 37 wherein the asset management entity manages a fiduciary instrument as a fiduciary or agent of a fiduciary and the client is a grantor or beneficiary of the fiduciary instrument.

43. The method of claim 42 wherein the fiduciary instrument comprises a trust instrument.

44. The method of claim 42 wherein the fiduciary instrument comprises a conservatorship instrument.

45. The method of claim 42 wherein the fiduciary instrument comprises an executorship.

46. The method of claim 37 wherein the asset management entity provides insurance services for an insurance policy involving the client.

47. The method of claim 37 wherein the asset management entity provides a real estate management service for real estate owned by the client.

48. The method of claim 37 wherein the asset management entity provides personal property management services for personal property owned by the client.

49. The method of claim 37 wherein the asset management entity provides property management service for real or personal property owned by the client.

50. The method of claim 37 wherein the compensation paid to the attorney includes compensation for legal services provided to the client prior to referring the client to the asset management entity.

51. The method of claim 37 wherein the legal services are provided to the client on a periodic basis and the attorney is compensated on a periodic basis over a period of time that the asset is managed by the asset management entity.

52. The method of claim 37 wherein the attorney is compensated by the asset management entity in proportion to the value of the asset being managed by the asset management entity.

53. The method of claim 37 wherein the attorney is compensated from fees charged by the asset management entity for managing the asset over a period of time.

54. The method of claim 37 wherein the attorney is selected by the client, and the asset management entity is referred to the client by the attorney.

55. The method of claim 37 wherein the asset management entity provides a membership affiliation with a plurality of member attorneys, each member attorney referring the services of the asset management entity to at least one client.

56. The method of claim 55 wherein the membership affiliation includes an agreement between the attorney and the asset management entity, the agreement providing that the attorney is required to provide a defined amount of legal services to the client over a defined period of time.

57. The method of claim 55, further comprising the asset management entity providing the affiliated member attorneys with instructional materials regarding the services available from the asset management entity.

58. The method of claim 55, further comprising the asset management entity providing the affiliated member attorneys with instructional materials regarding the legal services provided being provided to the client.

59. The method of claim 55, further comprising the asset management entity providing the affiliated member attorneys with secure access to an account that includes periodically updated information concerning the asset managed by the asset management entity to each client that the attorney refers to the asset management entity.

60. The method of claim 55, further comprising the asset management entity referring prospective clients to a member attorney to provide legal services regarding the asset managed by the asset managing entity.

61. The method of claim 55 wherein the membership affiliation is provided over a computer network.

62. The method of claim 61 wherein the computer network comprises the Internet.

63. The method of claim 55 wherein the affiliation of each attorney member is conditioned on there being at least one client of the member attorney member with an asset being managed by the asset management entity, and wherein management of the asset by the asset management entity is conditioned on the client receiving legal services by an affiliated member attorney.

64. The method of claim 63, further comprising transferring the asset of the client under management by the asset management entity to another entity selected by the client if the client ceases to receive legal services from the member attorney or the member attorney ceases to be affiliated with the asset management entity.

65. A third-party compensation method for providing legal services to a client, comprising;
establishing a relationship between an attorney and the client to provide legal services to the client concerning management of an asset owned by the client;
the attorney referring the client to an asset management entity to manage the asset of the client, the attorney being under an obligation to not accept fees for referring the client to the asset management entity;
establishing a relationship between the client and the asset management entity, and, pursuant to the relationship, the asset management entity managing the asset owned by the client and charging a fee to the client for managing the asset;
establishing a relationship between the attorney and the asset management entity; and
pursuant to the relationship between the attorney and the asset management entity, the asset management entity compensating the attorney for legal services provided to the client regarding the asset being managed by the asset management entity, the compensation being provided from the fees the asset management entity charges the client for the management of the asset.

66. A third-party compensation method for providing legal services to clients, comprising:
providing a network of member attorneys affiliated with an asset management entity;
the member attorneys providing legal services to clients regarding respective assets owned by the clients;
the member attorneys referring clients to the affiliated asset management entity, the member attorneys being under an obligation to not accept fees for referring the clients to the affiliated asset management entity;
the asset managing entity managing the respective assets of the clients, the asset management entity charging the clients fees for managing the assets; and
the asset management entity compensating each member attorney for the legal services provided by each member attorney to each of the member attorney's clients having an asset managed by the asset management entity.

67. A third-party compensation method for providing legal fees to an attorney comprising;
establishing a first relationship between a client and the attorney, the attorney providing legal advice to the client concerning the clients wealth and being under an obligation to not accept fees for referring the client to a wealth management entity;
establishing a second relationship between the client and a wealth management entity, the wealth management entity charging a fee to the client to manage the wealth of the client; and
establishing a third relationship between the wealth management entity and the attorney, the attorney referring the client to the wealth management entity and the wealth management entity compensating the attorney for legal services provided to the client.

68. A system for doing business comprising:
a first document establishing a first relationship between a client and an attorney, the first document specifying that the attorney will provide legal services to the client;
a second document establishing a second relationship between the client and an asset management entity, the second document providing for the asset management entity managing an asset of the client and charging a fee to the client for managing the asset of the client; and
a third document establishing a third relationship between the asset management entity and the attorney, at least one of the first, second and third documents specifying that the asset management entity will compensate the attorney for the legal services provided to the client by the attorney pursuant to the first document from the fee charged to the client pursuant to the second document.

69. The system of claim 68, wherein the third document provides for the referral by the attorney of clients to a asset management entity.

70. A system for doing business comprising computer communications media configured to communicate:
information establishing a first relationship between a client and an attorney, the information specifying that the attorney will provide legal services to the client;
information establishing a second relationship between the client and an asset management entity, the second relationship including the asset management entity charging a fee to the client to manage the assets of the client; and
information establishing a third relationship between the asset entity and the attorney, the third relationship including the asset management entity compensating the attorney for providing legal services to the client pursuant to the first relationship.

71. The system of claim 70 wherein the third relationship further includes the attorney referring clients to the asset management entity.

72. The system of claim 70 wherein the computer communications media is further configured to provide information identifying a set of member attorneys having established the third relationship with asset management entity and information identifying a corresponding set of clients having established the second relationship with the asset management entity.

73. The system of claim 70 wherein the computer communications media is further configured to provide secure account information regarding an asset being managed by the asset management entity for the client, the secure account information being accessible to the client, the asset management entity and the attorney providing legal services for the client.

74. The system of claim 70 wherein the computer communications media configured is further configured to provide information to the client and to the attorney concerning services offered by the asset management entity for managing the asset of the client.

75. The system of claim 70 wherein the computer communications media is further configured to provide selected information to the attorney, the selected information including instructional materials to aid the attorney in providing legal services for the client.

76. The system of claim 70 wherein the computer communications media transmits information over a computer network.

77. The system of claim 76 wherein the computer network comprises the Internet.
